(19) United States
(12) Patent Application Publication
(10) Pub. No.: US 2016/0337394 A1
(43) Pub. Date: Nov. 17, 2016

(54) NEWBORN DOMAIN SCREENING OF ELECTRONIC MAIL MESSAGES

(71) Applicant: THE BOEING COMPANY, HUNTINGTON BEACH, CA (US)

(72) Inventors: Elizabeth Ann Crowley, Bothell, WA (US); Rajpreet Ahluwalia, Kent, WA (US); Kevin Nikkel, Saint Peters, MO (US); Daniel O. Rothgeb, Seattle, WA (US)

(21) Appl. No.: 14/709,099

(22) Filed: May 11, 2015

(51) Int. Cl. H04L 29/06; H04L 29/08; G06F 17/30; H04L 12/58

(52) U.S. Cl. CPC H04L 63/1441; H04L 51/12; H04L 67/02; G06F 17/30979

(57) ABSTRACT

An apparatus is provided for implementation of a system for screening electronic mail messages. The apparatus may receive an electronic mail message, and scan the electronic mail message for a uniform resource identifier (URI) of an Internet resource embedded therein. In an instance in which a URI is embedded in the electronic mail message, the apparatus may query a WHOIS server for a created date of the Internet resource. In this regard, the WHOIS server may be queried using a domain name of the Internet resource included in the URI. And the apparatus may determine an age of the Internet resource from the created date, and perform a remedial action in an instance in which the age of the Internet resource is less than a threshold age.

### TECHNOLOGICAL FIELD

The present disclosure relates generally to computer security and, in particular, to newborn domain screening of electronic mail messages to identify links to malicious Internet resources.

### BACKGROUND

Despite the constant evolution of computer security, computer systems and networks are perpetually susceptible to exploitation by attackers, or more particularly hackers, such as through application of malware. These attackers may have any of a number of motivations, from pure enjoyment to cyberwarfare in which a nation-state penetrates the computer system or network of another nation for sabotage and espionage.

An advanced persistent threat (APT) describes an attacker that infects a target computer by some entry mechanism and installs malware that can perform actions for the attacker. After being installed, the malware may begin to “call out” or “beacon” to a host or list of hosts via a computer network, typically on a regular and recurring basis. A purpose of these callouts or beacons may be to bypass corporate or personal firewalls that tend to prevent most incoming traffic but allow most outgoing traffic. The malware may allow the attacker to instruct or control the victim device to carry out actions for the attacker, such as surveying other computing systems, collecting data from the infected device, and/or exfiltrating information back to the attacker.

There are a number of entry mechanisms that attackers use to infect target computers. One entry mechanism involves the use of an electronic mail (email) message with an embedded link including a uniform resource locator (URL) to malware, here a malicious Internet resource. This email message typically encourages the end-user to click on the link and initiate malware execution outside any e-mail security process. Existing e-mail security controls are less effective at dealing with this type of threat than traditional threats (where the malware might be embedded directly in the e-mail message or an attachment) because the malware is not delivered as part of the e-mail message, and therefore is not available for scanning/evaluation.

### BRIEF SUMMARY

Example implementations of the present disclosure are directed to an improved system, method and computer-readable storage medium for screening electronic mail messages. It has been found that attackers who embed links to malware often register a new domain specifically to host the malware, and then generate emails with links to the malware. This practice is also often employed to deliver spam and carry out phishing attacks that also involve malicious Internet resources. While not all newly-registered domains point to malicious Internet resource, the risk of falsely judging a link with a newly-registered domain is often far less than one accessing one of these types of Internet resources.

A number of URL reputation services exist that scan URLs and identify them as safe or malicious. But there are so many URLs in existence that these services cannot keep up with the demand. As a consequence, URLs that are not widely used or are newly created often pass through these reputation services. Example implementations of the present disclosure scan email messages to identify newly-created domains as “newborn” and then perform an appropriate remedial action to reduce the likelihood of their being accessed, and thereby reduce the likelihood of a malicious infection intended to harm a computer system or network.

According to one aspect of example implementations, an apparatus is provided for implementation of a system for screening electronic mail messages. The apparatus includes a processor and a memory storing executable instructions that in response to execution by the processor cause the apparatus to implement at least a scanner, WHOIS client and control. The scanner is configured to receive an electronic mail (email) message, and scan the electronic mail message for a uniform resource identifier (URI) of an Internet resource embedded therein, with the URI in some examples being a uniform resource locator (URL).

In some examples, the email message includes a message body, and the scanner may be configured to scan the message body for a URI. Additionally or alternatively, in some examples, the email message may include an attached file, and the scanner may be configured to scan the attached file for a URI.

The WHOIS client may be coupled to the scanner and in an instance in which a URI is embedded in the email message, configured to query a WHOIS server for a created date of the Internet resource. The WHOIS server may be queried using information contained in the URI from which the Internet resource is identifiable. In some examples, the information may be a domain name of the Internet resource included in the URL, and the created date may correspond to a date on which the domain name was registered with a domain name registry.

The control may be coupled to the WHOIS client and configured to determine an age of the Internet resource from the created date. And the control may be configured to perform a remedial action in an instance in which the age of the Internet resource is less than a threshold age. In some examples, the control may be configured to block delivery of the email message to a recipient to which the email message is addressed. In some examples, the control may be configured to delete the URI from the email message before delivery of the email message to a recipient to which the email message is addressed. In these examples, the control may further add a user-notification regarding the deleted URI to the email message in place of the URI.

In other aspects of example implementations, a method and computer-readable storage medium are provided for screening email messages. The features, functions and advantages discussed herein may be achieved independently in various example implementations or may be combined in yet other example implementations further details of which may be seen with reference to the following description and drawings.

### BRIEF DESCRIPTION OF THE DRAWING(S)

Having thus described example implementations of the disclosure in general terms, reference will now be made to the accompanying drawings, which are not necessarily drawn to scale, and wherein:

FIG. 1 is an illustration of a network system that may benefit from an electronic mail (email) message screening system, in accordance with example implementations of the present disclosure;

FIG. 2 illustrates an example email screening system, according to some example implementations;

FIG. 3 is a flowchart illustrating various steps in a method for screening email messages, according to some example implementations; and

FIG. 4 illustrates an apparatus according to some example implementations.

### DETAILED DESCRIPTION

Some implementations of the present disclosure will now be described more fully hereinafter with reference to the accompanying drawings, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

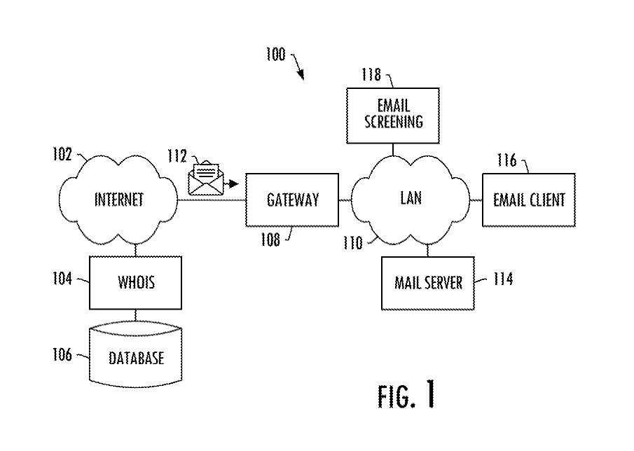

Example implementations of the present disclosure are generally directed to newborn domain screening of electronic mail (email) messages to identify links to malicious Internet resources. Example implementations may be useful in a number of different network systems in which email messages may be communicated. FIG. 1 illustrates one example of a network system 100 in which example implementations may be useful. The network system may include one or more of each of a number of components. As shown, for example, the network system may include a wide area network such as the Internet 102 through which Internet resources are accessible.

As is known, the Internet 102 employs the Domain Name System (DNS) whereby Internet resources are assigned domain names that may be translated to corresponding Internet Protocol (IP) addresses for those resources. Through a domain name registrar, these domain names may be registered with a domain name registry, which may be accessed to properly locate an IP address for a given domain name so that its Internet resource may be accessed.

As is also known, WHOIS is a query and response protocol whereby information regarding registered domain names and their respective registrants may be accessed from one or more databases in which that information may be stored. The protocol may be implemented by server computers sometimes referred to as WHOIS servers who maintain respective databases of this information. These WHOIS servers and databases may be associated with or separate from domain name registrars. FIG. 1 illustrates a WHOIS server 104 and database 106, but it should be understood that there may be a number of distributed WHOIS servers and databases that communicate with one another and/or domain name registrars to provide information regarding registered domain names and their respective registrants.

The Internet 102 is composed of a number of computers and computer networks that are interconnected by a variety of different networking hardware such as routers, switches, gateways and the like. This networking hardware may also allow smaller-scale networks to connect to the Internet. As shown, for example, a gateway 108 may connect the Internet to a smaller-scale network such as a local area network (LAN) 110. Although shown as a LAN, it should be understood that example implementations may be equally applicable to any of a number of other types of smaller-scale networks.

The network system 100 may provide a number of different resources to users, one typical example of which is electronic mail (email). Here again, as known, email is a technique for exchanging digital messages (i.e., email messages) from a sender to one or more recipients. Email messages may be sent from and received entirely within the LAN 110. Email messages may be sent from another LAN and received from across the Internet 102 (as shown for email message 112); or sent from the LAN 110 across the Internet for receipt within another LAN. At the receiving end of an email message, a mail server (computer) 114 accepts the email message and routes it to the recipient's mailbox. The recipient may then use an appropriate email client 116 (locally on the LAN or across the LAN) to access the email message. And for this, the email client may be of any of a number of suitable types operable on any of a number of suitable computers, including personal computers, mobile computers and the like.

As explained in the Background section, there are a number of entry mechanisms that attackers use to infect target computers to carry out a cyber-attack. One entry mechanism involves the use of an electronic mail (email) message with an embedded link to a malicious Internet resource, such as to deliver malware or spam, carry out phishing attack. It has been found that attackers who embed a link to a malicious Internet resource often register a new domain specifically for this purpose, and then generate an email with a link to the malicious Internet resource. Example implementations of the present disclosure therefore provide an email screening system 118 configured to screen email messages 112 before their delivery to a recipient through their email client 116.

The email screening system 118 may be configured to screen email messages 112 at any point during communication from its sender but before being accessed by its recipient. For example, the email screening system may be configured to screen email messages before, after or as those messages pass through the gateway 108 for receipt by the mail server 114. In another example, the email screening system may be configured to screen email messages after those messages pass the gateway but before, after or as those messages are received by the mail server. Or in some examples, the email system may be configured to screen email messages after those messages are routed to the recipient's mailbox, but before those messages are accessible by the recipient from their email client 116.

It will therefore be appreciated that, as shown, the email screening system 118 may be connected to the LAN 110, and thereby configured to communicate with any of the gateway 108, mail server 114 or email client 116. Or in some examples, the email screening system may be integrated with any of the gateway, mail server or email client.

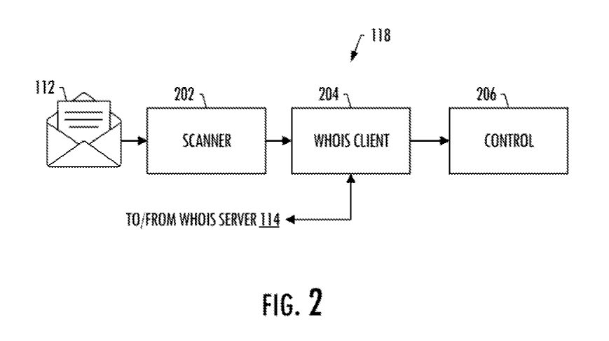

Reference is now made to FIG. 2, which more particularly illustrates the email screening system 118, according to some example implementations. The email screening system may include any of a number of different subsystems (each an individual system) for performing one or more functions or operations with respect to an email message 112. As shown, for example, the email screening system may include a scanner 202, a WHOIS client 204 and a control 206 coupled to one another. Although being shown together as part of the system, it should be understood that any one or more of the scanner, WHOIS client or control may function or operate as a separate system without regard to the other. And further, it should be understood that the email screening system may include one or more additional or alternative subsystems than those shown in FIG. 2.

The scanner 202 may be configured to receive an email message 112, and scan the email message for a uniform resource identifier (URI) of an Internet resource embedded therein. In some examples, this URI may be provided in the form of a link to the Internet resource. The email message may include a message body, and in some examples may also include an attached file. The scanner may be configured to scan the message body, any attached file or both the message body and any attached file for a URI. In some examples, the URI may be a uniform resource locator (URL). Or in other examples, the URI may identify the Internet resource without specifying a particular means of accessing the resource (e.g., http, ftp), which a URL may specify in addition to the Internet resource.

In an instance in which a URI is embedded in the email message 112, the scanner 202 may trigger the WHOIS client 204 to query the WHOIS server 104 for a created date of the Internet resource, which may correspond to the date on which a domain name in the URI was registered with a domain name registry. The WHOIS client may query the WHOIS server using information contained in the URI from which the Internet resource is identifiable. In some examples, this information may be the domain name of the Internet resource. In other examples, the information may be the IP address for a given domain name, or even a partial domain name. The created date, then, may correspond to the date on which the domain name was registered with the domain name registry, such as part of the Domain Name System (DNS).

The control 206 may be configured to determine an age of the Internet resource from the created date. In some examples, the age may of the Internet resource may be calculated by comparison of the created date to the current date. Or in other examples, the age of the Internet resource may be simply inferred from the created date.

The control 206 may then be configured to perform a remedial action in an instance in which the age of the Internet resource is less than a threshold age, in which case the domain for the Internet resource may be considered newborn. The threshold age may be set to any of a number of different values, and in some examples may be customizable. Some examples of suitable threshold ages in different situations include one hour, one day, five days, fourteen days, thirty days and the like.

The age of the Internet resource being less than the threshold age may provide some indication that the Internet resource is malicious, and the control 206 may be configured to perform any of a number of different suitable remedial actions in response thereto. For example, the control may be configured to block delivery of the email message 112 to the recipient to which the email message is addressed. In another example, the control may simply delete the URI from the email message before its delivery of the email message to the recipient; or the control may delete the URI and replace it with a suitable user-notification regarding the deleted URI.

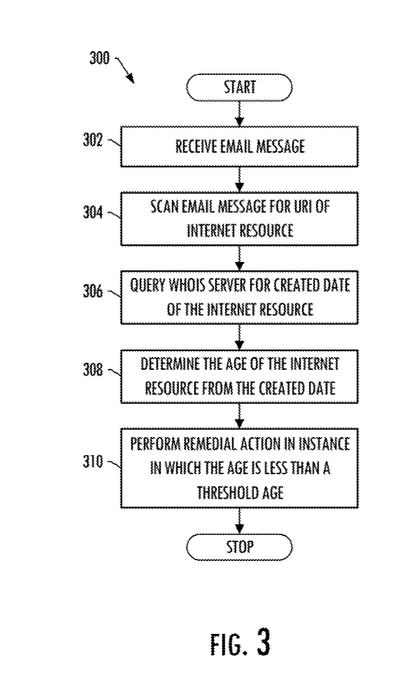

FIG. 3 is a flowchart illustrating various steps in a method 300 of screening email messages. As shown at blocks 302 and 304, the method may include receiving an email message, and scanning the email message for a URI of an Internet resource embedded therein. This may include scanning the message body and/or an attached file. In an instance in which a URI is embedded in the email message, the method may include querying a WHOIS server for a created date of the Internet resource, with the WHOIS server being queried using information contained in the URI from which the Internet resource may be identifiable (e.g., its domain name, IP address, partial domain name), as shown in block 306. This created date may correspond to the date on which the domain name was registered with a domain name registry. In this instance, the method may also include determining an age of the Internet resource from the created date, and performing a remedial action in an instance in which the age of the Internet resource is less than a threshold age, as shown in blocks 308 and 310.

In some examples, performing the remedial action may include blocking delivery of the email message to a recipient to which the email message is addressed. In some examples, performing the remedial action may include deleting the URI from the email message before delivery of the email message to a recipient to which the email message is addressed. And in some of these examples, performing the remedial action may further include adding a user-notification regarding the deleted URI to the email message in place of the URI.

According to example implementations of the present disclosure, the email screening system 118 and its subsystems including the scanner 202, WHOIS client 204 and/or control 206 may be implemented by various means. Means for implementing the email screening system and its subsystems may include hardware, alone or under direction of one or more computer programs from a computer-readable storage medium. In some examples, one or more apparatuses may be configured to function as or otherwise implement the email screening system and its subsystems shown and described herein. In examples involving more than one apparatus, the respective apparatuses may be connected to or otherwise in communication with one another in a number of different manners, such as directly or indirectly via a wired or wireless network or the like.

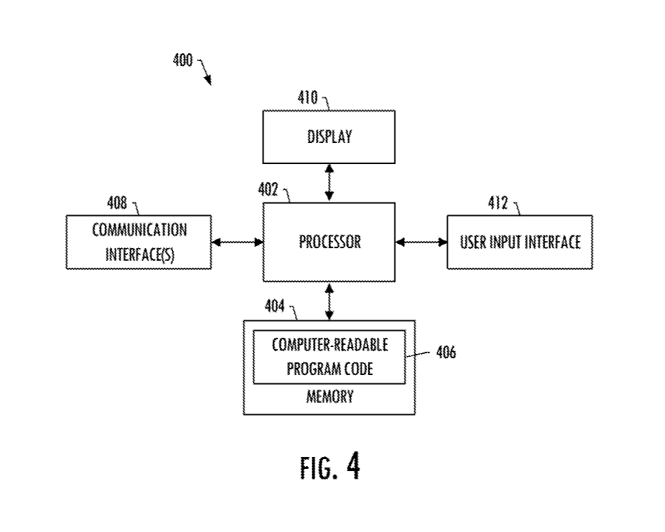

FIG. 4 illustrates an apparatus 400 according to some example implementations of the present disclosure. Generally, an apparatus of exemplary implementations of the present disclosure may comprise, include or be embodied in one or more fixed or portable electronic devices. Examples of suitable electronic devices include a smartphone, tablet computer, laptop computer, desktop computer, workstation computer, server computer or the like. The apparatus may include one or more of each of a number of components such as, for example, a processor 402 (e.g., processor unit) connected to a memory 404 (e.g., storage device).

The processor 402 is generally any piece of computer hardware that is capable of processing information such as, for example, data, computer programs and/or other suitable electronic information. The processor is composed of a collection of electronic circuits some of which may be packaged as an integrated circuit or multiple interconnected integrated circuits (an integrated circuit at times more commonly referred to as a “chip”). The processor may be configured to execute computer programs, which may be stored onboard the processor or otherwise stored in the memory 404 (of the same or another apparatus).

The processor 402 may be a number of processors, a multi-processor core or some other type of processor, depending on the particular implementation. Further, the processor may be implemented using a number of heterogeneous processor systems in which a main processor is present with one or more secondary processors on a single chip. As another illustrative example, the processor may be a symmetric multi-processor system containing multiple processors of the same type. In yet another example, the processor may be embodied as or otherwise include one or more application-specific integrated circuits (ASICs), field-programmable gate arrays (FPGAs) or the like. Thus, although the processor may be capable of executing a computer program to perform one or more functions, the processor of various examples may be capable of performing one or more functions without the aid of a computer program.

The memory 404 is generally any piece of computer hardware that is capable of storing information such as, for example, data, computer programs (e.g., computer-readable program code 406) and/or other suitable information either on a temporary basis and/or a permanent basis. The memory may include volatile and/or non-volatile memory, and may be fixed or removable. Examples of suitable memory include random access memory (RAM), read-only memory (ROM), a hard drive, a flash memory, a thumb drive, a removable computer diskette, an optical disk, a magnetic tape or some combination of the above. Optical disks may include compact disk-read only memory (CD-ROM), compact disk-read/write (CD-R/W), DVD or the like. In various instances, the memory may be referred to as a computer-readable storage medium. The computer-readable storage medium is a non-transitory device capable of storing information, and is distinguishable from computer-readable transmission media such as electronic transitory signals capable of carrying information from one location to another. Computer-readable medium as described herein may generally refer to a computer-readable storage medium or computer-readable transmission medium.

In addition to the memory 404, the processor 402 may also be connected to one or more interfaces for displaying, transmitting and/or receiving information. The interfaces may include a communications interface 408 (e.g., communications unit) and/or one or more user interfaces. The communications interface may be configured to transmit and/or receive information, such as to and/or from other apparatus(es), network(s) or the like. The communications interface may be configured to transmit and/or receive information by physical (wired) and/or wireless communications links. Examples of suitable communication interfaces include a network interface controller (NIC), wireless NIC (WNIC) or the like.

The user interfaces may include a display 410 and/or one or more user input interfaces 412 (e.g., input/output unit). The display may be configured to present or otherwise display information to a user, suitable examples of which include a liquid crystal display (LCD), light-emitting diode display (LED), plasma display panel (PDP) or the like. The user input interfaces may be wired or wireless, and may be configured to receive information from a user into the apparatus, such as for processing, storage and/or display. Suitable examples of user input interfaces include a microphone, image or video capture device, keyboard or keypad, joystick, touch-sensitive surface (separate from or integrated into a touchscreen), biometric sensor or the like. The user interfaces may further include one or more interfaces for communicating with peripherals such as printers, scanners or the like.

As indicated above, program code instructions may be stored in memory, and executed by a processor, to implement functions of the systems, subsystems, tools and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, a processor or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processor or other programmable apparatus to configure the computer, processor or other programmable apparatus to execute operations to be performed on or by the computer, processor or other programmable apparatus.

Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processor or other programmable apparatus provide operations for implementing functions described herein.

Execution of instructions by a processor, or storage of instructions in a computer-readable storage medium, supports combinations of operations for performing the specified functions. In this manner, an apparatus 400 may include a processor 402 and a computer-readable storage medium or memory 404 coupled to the processor, where the processor is configured to execute computer-readable program code 406 stored in the memory. It will also be understood that one or more functions, and combinations of functions, may be implemented by special purpose hardware-based computer systems and/or processors which perform the specified functions, or combinations of special purpose hardware and program code instructions.

Many modifications and other implementations of the disclosure set forth herein will come to mind to one skilled in the art to which the disclosure pertains having the benefit of the teachings presented in the foregoing description and the associated drawings. Therefore, it is to be understood that the disclosure is not to be limited to the specific implementations disclosed and that modifications and other implementations are intended to be included within the scope of the appended claims. Moreover, although the foregoing description and the associated drawings describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus for implementation of a system for screening electronic mail messages, the apparatus comprising a processor and a memory storing executable instructions that in response to execution by the processor cause the apparatus to implement at least:
a scanner configured to receive an electronic mail message, and scan the electronic mail message for a uniform resource identifier (URI) of an Internet resource embedded therein;
a WHOIS client coupled to the scanner and in an instance in which a URI is embedded in the electronic mail message, configured to query a WHOIS server for a created date of the Internet resource, the WHOIS server being queried using information contained in the URI from which the Internet resource is identifiable; and
a control coupled to the WHOIS client and configured to determine an age of the Internet resource from the created date, and perform a remedial action in an instance in which the age of the Internet resource is less than a threshold age.

2. The apparatus of claim 1, wherein the electronic mail message includes a message body, and the scanner being configured to scan the electronic mail message includes being configured to scan the message body for a URI.

3. The apparatus of claim 1, wherein the electronic mail message includes an attached file, and the scanner being configured to scan the electronic mail message includes being configured to scan the attached file for a URI.

4. The apparatus of claim 1, wherein the information is a domain name of the Internet resource included in the URL, and the WHOIS client being configured to query the WHOIS server includes being configured to query the WHOIS server for the created date corresponding to a date on which the domain name was registered with a domain name registry.

5. The apparatus of claim 1, wherein the control being configured to perform the remedial action includes being configured to block delivery of the electronic mail message to a recipient to which the electronic mail message is addressed.

6. The apparatus of claim 1, wherein the control being configured to perform the remedial action includes being configured to delete the URI from the electronic mail message before delivery of the electronic mail message to a recipient to which the electronic mail message is addressed.

7. The apparatus of claim 6, wherein the control being configured to perform the remedial action further includes being configured to add a user-notification regarding the deleted URI to the electronic mail message in place of the URI.

8. A method of screening electronic mail messages, the method comprising:
receiving an electronic mail message;
scanning the electronic mail message for a uniform resource identifier (URI) of an Internet resource embedded therein; and in an instance in which a URI is embedded in the electronic mail message,
querying a WHOIS server for a created date of the Internet resource, the WHOIS server being queried using information contained in the URI from which the Internet resource is identifiable;
determining an age of the Internet resource from the created date; and
performing a remedial action in an instance in which the age of the Internet resource is less than a threshold age.

9. The method of claim 8, wherein the electronic mail message includes a message body, and scanning the electronic mail message includes scanning the message body for a URI.

10. The method of claim 8, wherein the electronic mail message includes an attached file, and scanning the electronic mail message includes scanning the attached file for a URI.

11. The method of claim 8, wherein the information is a domain name of the Internet resource included in the URL, and querying the WHOIS server includes querying the WHOIS server for the created date corresponding to a date on which the domain name was registered with a domain name registry.

12. The method of claim 8, wherein performing the remedial action includes blocking delivery of the electronic mail message to a recipient to which the electronic mail message is addressed.

13. The method of claim 8, wherein performing the remedial action includes deleting the URI from the electronic mail message before delivery of the electronic mail message to a recipient to which the electronic mail message is addressed.

14. The method of claim 13, wherein performing the remedial action further includes adding a user-notification regarding the deleted URI to the electronic mail message in place of the URI.

15. A computer-readable storage medium for screening electronic mail messages, the computer-readable storage medium being non-transitory and having computer-readable program code portions stored therein that in response to execution by a processor, cause an apparatus to at least:
receive an electronic mail message;
scan the electronic mail message for a uniform resource identifier (URI) of an Internet resource embedded therein; and in an instance in which a URI is embedded in the electronic mail message,
query a WHOIS server for a created date of the Internet resource, the WHOIS server being queried using information contained in the URI from which the Internet resource is identifiable;
determine an age of the Internet resource from the created date; and
perform a remedial action in an instance in which the age of the Internet resource is less than a threshold age.

16. The computer-readable storage medium of claim 15, wherein the electronic mail message includes a message body, and the apparatus being caused to scan the electronic mail message includes being caused to scan the message body for a URI.

17. The computer-readable storage medium of claim 15, wherein the electronic mail message includes an attached file, and the apparatus being caused to scan the electronic mail message includes being caused to scan the attached file for a URI.

18. The computer-readable storage medium of claim 15, wherein the information is a domain name of the Internet resource included in the URL, and the apparatus being caused to query the WHOIS server includes being caused to query the WHOIS server for the created date corresponding to a date on which the domain name was registered with a domain name registry.

19. The computer-readable storage medium of claim 15, wherein the apparatus being caused to perform the remedial action includes being caused to block delivery of the electronic mail message to a recipient to which the electronic mail message is addressed.

20. The computer-readable storage medium of claim 15, wherein the apparatus being caused to perform the remedial action includes being caused to delete the URI from the electronic mail message before delivery of the electronic mail message to a recipient to which the electronic mail message is addressed.

21. The computer-readable storage medium of claim 20, wherein the apparatus being caused to perform the remedial action further includes being caused to add a user-notification regarding the deleted URI to the electronic mail message in place of the URI.
